(19) United States
(12) Patent Application Publication
(10) Pub. No.: US 2020/0184479 A1
(43) Pub. Date: Jun. 11, 2020

(54) SYSTEMS FOR MANAGING CRYPTOCURRENCY TRANSACTIONS

(71) Applicant: Capital One Services, LLC, McLean, VA (US)

(72) Inventors: Abdelkader M'Hamed Benkreira, Arlington, VA (US); Joshua Edwards, Philadelphia, PA (US); Michael Mossoba, Arlington, VA (US)

(73) Assignee: Capital One Services, LLC, McLean, VA (US)

(21) Appl. No.: 16/210,860

(22) Filed: Dec. 5, 2018

(51) Int. Cl. G06Q 20/40; G06Q 20/38; G06Q 20/06

(52) U.S. Cl. CPC G06Q 20/4016; G06Q 2220/00; G06Q 20/0658; G06Q 20/389

(57) ABSTRACT

Computer-implemented systems are provided for managing cryptocurrency transactions. Consistent with disclosed embodiments, the systems may comprise at least one processor; and at least one memory device. The memory device may contain instructions that, when executed by the at least one processor, cause the system to perform operations. The operations may include receiving, from a third party, information relating to a cryptocurrency account. The operations may also include storing the information in a database. The operations may also include receiving, from a user, a request to investigate the account. The operations may also include identifying a characteristic associated with the account. The operations may also include determining a risk factor for the account, based at least in part on the characteristic, and sending, to the user, a first command to display the risk factor.

### TECHNICAL FIELD

The disclosed embodiments concern a system for managing cryptocurrency transactions. More specifically, the disclosed embodiments concern systems for receiving, from a third party, information relating to a cryptocurrency account and determining whether a cryptocurrency account is trustworthy. Additional embodiments relate to warning a user using an electronic device as to whether a proposed transaction with a cryptocurrency account presents risks.

### BACKGROUND

Cryptocurrency, a digital medium of exchange, is becoming more and more widely used. It is a decentralized currency, meaning that the currency can be sent from user-to-user without intermediaries, such as, a central bank. Cryptocurrency transactions may be recorded in a public ledger called the “blockchain,” meaning that a third party may see transactions between two parties even though they may not know who the parties are.

Generally, cryptocurrency is anonymous, meaning that funds are not tied to real-world entities but rather a cryptocurrency address or a cryptocurrency account. Owners of the addresses are not explicitly identified, but all transactions on the blockchain are public. Thus, one can only guess the identities using public transaction data and known information on owners of certain addresses or accounts. As the numbers of cryptocurrency accounts and transactions increase, so also does the need for more sophisticated methods for preventing fraud and determining the trustworthiness of cryptocurrency accounts. Users generally do not want to willingly transact with illicit organizations (e.g., terrorists, organized crime, scammers) but this can be difficult given the decentralized and anonymous nature of cryptocurrency.

Because cryptocurrency systems are designed to be anonymous and decentralized, risk management can be difficult when engaging in cryptocurrency transactions. Therefore, there is a growing need to implement a system to prevent fraud and lower the risks for users of cryptocurrency.

### SUMMARY

The disclosed embodiments concern a system that manages cryptocurrency transactions. As described in greater detail below, this system may solve the above-mentioned technical problems.

In some embodiments, a system for managing cryptocurrency transactions comprising at least one processor; and at least one memory device. The memory device may contain instructions that, when executed by the at least one processor, cause the system to perform operations. The operations may comprise receiving, from a third party, information relating to a cryptocurrency account. The operations may also comprise storing the information in a database. The operations may also comprise receiving, from a user, a request to investigate the account. The operations may also comprise identifying a characteristic associated with the account. The operations may also comprise determining a risk factor for the account, based at least in part on the characteristic, and sending, to the user, a first command to display the risk factor.

In some embodiments, a system for managing cryptocurrency transactions comprising at least one processor; and at least one memory device. The memory device may contain instructions that, when executed by the at least one processor, cause the system to perform operations. The operations may comprise receiving, from a third party, a report of a first cryptocurrency account. The operations may also comprise storing the report in a database. The operations may also comprise performing an analysis of a blockchain related to the first account. The operations may also comprise determining a risk factor for the first account based on the analysis. The operations may also comprise receiving, from a user, a preference for a warning. The operations may also comprise receiving, from the user, a request to investigate a second cryptocurrency account. The operations may also comprise comparing the second account with the first account. The operations may also comprise determining whether the second account is suspicious, based on the comparison, and sending a command to display a warning to the user, based on the warning preference, when the second account is suspicious.

It is to be understood that both the foregoing general description and the following detailed description are exemplary and explanatory only and are not restrictive of the disclosed embodiments, as claimed.

### BRIEF DESCRIPTION OF THE DRAWINGS

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. In the drawings:

FIG. 1 is a schematic diagram of an exemplary system for managing cryptocurrency transactions, consistent with disclosed embodiments.

FIG. 2 is a block diagram of a cryptocurrency transaction system, consistent with disclosed embodiments.

FIG. 3 is a block diagram of a user device, consistent with disclosed embodiments.

FIG. 4 is a flowchart of an exemplary method for managing cryptocurrency transactions, consistent with disclosed embodiments.

FIG. 5 is a flowchart another exemplary method for managing cryptocurrency transactions, consistent with disclosed embodiments.

FIG. 6A illustrates an exemplary screen display on a mobile device for selecting a user preference, consistent with disclosed embodiments.

FIG. 6B illustrates an exemplary screen display on a mobile device for presenting a warning to a user, consistent with disclosed embodiments.

FIG. 6C illustrates another exemplary screen display on a mobile device for presenting a warning to a user, consistent with disclosed embodiments.

FIG. 7 is a diagram showing an exemplary user interface, consistent with disclosed embodiments.

FIG. 8A is an exemplary interface on a screen of a computing device for receiving user input, consistent with disclosed embodiments.

FIG. 8B is an exemplary screen display on a computing device for presenting a warning to a user, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

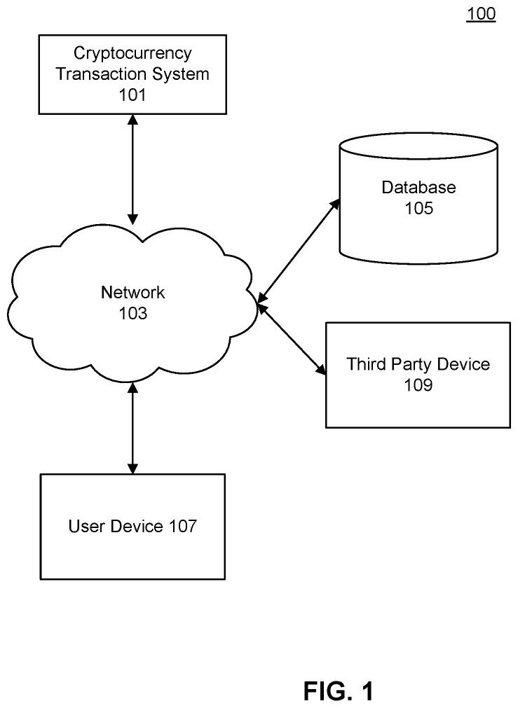

FIG. 1 is a schematic of an exemplary system 100 for managing cryptocurrency transactions. System 100 may comprise a cryptocurrency transaction system 101, a network 103, a database 105, a user device 107, and a third party device 109.

In some embodiments, cryptocurrency transaction system 101 may be implemented as a server, a general-purpose computer, a mainframe computer, or the like. As further described herein, components of cryptocurrency transaction system 101 may include one or more computing devices (e.g., computer(s), server(s), etc.), memory storing data and/or software instructions (e.g., database(s), memory devices, etc.), and other known computing components. In some embodiments, the one or more computing devices are configured to execute software instructions stored on one or more memory devices to perform one or more operations consistent with the disclosed embodiments.

Cryptocurrency transaction system 101 comprises storage for software that, when executed, causes cryptocurrency transaction system 101 to send and/or receive information from devices such as user device 107. In one example embodiment, the software may be operable to send and/or receive information from other devices, such as third party device 109, using network 103. For example, the software may be configured to enable cryptocurrency transaction system 101 to receive information from third party device 109 and user device 107 over a Bluetooth connection, over a wireless network connection (e.g., 802.11 a/b/g/n), a WiFi connection, or other standard or proprietary communication protocol (e.g., HyperText Transfer Protocol (HTTP) and/or File Transfer Protocol (FTP), etc.). The information may include, for example, a complaint, a notification that a cryptocurrency account is fraudulent, a list of known fraudulent accounts, or an indication that a cryptocurrency account may be involved in a terrorist group or a problematic organization. In some aspects, the information may be obfuscated or encrypted according to methods known to one of skill in the art. For example, information received by cryptocurrency transaction system 101 may be encrypted with a cryptographic key. Upon receiving the information, cryptocurrency transaction system 101 may be configured to decrypt the information.

In some embodiments, cryptocurrency transaction system 101, user device 107 and third party device 109 are not limited to using network or other local wireless connections to communicate directly with one another. For example, cryptocurrency transaction system 101 and user device 107 may be configured to exchange data by communicating with a separate device connected to network 103.

In some embodiments, cryptocurrency transaction system 101 may be configured to store/retrieve data using a database (e.g., database 105) using software instructions, such as, for example, Structured Query Language (SQL). For example, cryptocurrency transaction system 101 may store information retrieved from a digital ledger or “blockchain” (not pictured) in database 105. A blockchain may be conceptually thought of as a growing chain of data called “blocks” which are linked using cryptography. For example, each block contains a portion of cryptographic code from the previous block, a timestamp, and transaction data, such as, the amount in each transaction, the cryptocurrency accounts or addresses that participated in the transaction, etc. A blockchain records transactions between two parties using a peer-to-peer network, which can distribute the recorded data across the blockchain participants. Once recorded, in some embodiments, the data in a particular block cannot be changed (retroactively) unless the subsequent blocks are also changed. In some embodiments, such a ledger may store information about transactions performed using one or more cryptocurrencies, such as the amount in each transaction, the cryptocurrency accounts or addresses that participated in the transaction, and other data. Data on each block and each digital ledger may be accessed and retrieved using a network (i.e. the Internet). Cryptocurrency transaction system 101 may be configured to receive a request to investigate a cryptocurrency account. In some embodiments, cryptocurrency transaction system 101 may be configured to receive the request from user device 107, or from another system. Cryptocurrency transaction system 101 may be configured to interact with database 105 and blockchain to process the request. In some embodiments, processing the request comprises retrieving the information of the cryptocurrency account from database 105 and blockchain.

Cryptocurrency transaction system 101 may be configured to use the information to identify characteristics associated with the account. For example, such characteristics may include “suspicious location,” “account soon to be deactivated,” “problematic organization involved,” “involved in transaction with known fraudulent cryptocurrency accounts,” “transaction amount exceeds 300 units” (i.e., 300 of whatever currency is at issue), and/or “ratio of received transactions to sent transactions being too high,” etc. In some embodiments, identifying characteristics may comprise comparing the information with a set of pre-determined parameters. For example, when the geographic location of an account holder falls in a specific area that is known to be the source of problematic accounts, then cryptocurrency transaction system 101 may identify the account as “suspicious location.” As another example, when the remaining lifespan of public key of an account is less than a week, then cryptocurrency transaction system 101 may identify the account as “account soon to be deactivated.” These characteristics may be used as tags for the accounts when sorting them. For example, when monitoring transactions, to allocate our resources efficiently, cryptocurrency transaction system 101 may be configured to filter out the accounts that have not transacted at least 300 units of whatever cryptocurrency is used by the account. As another example, cryptocurrency transaction system 101 may be configured to flag the accounts with the same characteristics. For example, cryptocurrency transaction system 101 may be configured to flag all accounts that are identified to have “high ratio of received transactions to sent transactions.” Thus, users may gain a better understanding of whether the account is likely to be fraudulent and/or risky.

Cryptocurrency transaction system 101 may be configured to compare addresses/accounts in historical transactions of a cryptocurrency account in question with the list of known fraudulent addresses/accounts. When a fraudulent cryptocurrency account is detected in historical transactions of an account in question, then cryptocurrency transaction system 101 may identify the account in question as “involved in transaction with known fraudulent cryptocurrency accounts.” In some aspects, cryptocurrency transaction system 101 may be configured to compare addresses/accounts in historical transactions of a cryptocurrency account in question with lists of cryptocurrency accounts that may be involved in a terrorist group or a problematic organization. When more than one account in the transaction history matches the lists of cryptocurrency accounts that may be involved in a terrorist group or a problematic organization, then cryptocurrency transaction system 101 may identify the account in question to be “terrorist group related.” In some aspects, cryptocurrency transaction system 101 may be configured to record a number of transactions that a cryptocurrency account transacted with a problematic organization (e.g., a terrorist group). When the number is greater than a pre-determined threshold (e.g., three transactions), then cryptocurrency transaction system 101 may identify the account in question to be “terrorist group related” and/or “interact with a terrorist group frequently.” In some aspects, cryptocurrency transaction system 101 may be configured to record an amount of cryptocurrency units that a cryptocurrency account transacted with a terrorist group or a problematic organization. When the accumulated amount is greater than a pre-determined threshold (e.g., 10 units), then cryptocurrency transaction system 101 may identify the account in question to be “terrorist group related” and/or “deeply related to a terrorist group.” In some aspects, cryptocurrency transaction system 101 may be configured to record a number of transactions a cryptocurrency account received from a terrorist group or a problematic organization and a number of transactions a cryptocurrency account in question sent to a terrorist group or a problematic organization. When the number of transactions a cryptocurrency account in question received from a terrorist group or a problematic organization is greater than the number of transactions a cryptocurrency account in question sent to a terrorist group or a problematic organization, then cryptocurrency transaction system 101 may identify the account in question to be “terrorist group related” and/or “received transactions from a terrorist group frequently.” When the number of transactions a cryptocurrency account in question sent to a terrorist group or a problematic organization is greater than the number of transactions a cryptocurrency account in question received from a terrorist group or a problematic organization, then cryptocurrency transaction system 101 may identify the account in question to be “terrorist group related” and/or “sent transactions to a terrorist group frequently.” These identifications are provided as examples only; numerous other identifications are possible (as well as the ability to determine multiple identifications about a single account).

Cryptocurrency transaction system 101 may be configured to determine a risk factor for a cryptocurrency account. A risk factor indicates how risky it is to engage in a transaction with the cryptocurrency account. A risk factor may weight different characteristics. That said, some characteristics may be considered riskier than others, and thus, instead of each characteristic contributing equally to the risk factor, some characteristics may, in some embodiments, contribute more than others. A risk factor may be used, for example, to determine whether the account is suspicious or how suspicious the account is. For example, one range of risk factors would typically indicate a low risk, another range may indicate a suspicious account, and yet another range may indicate a clearly fraudulent account. Cryptocurrency transaction system 101 may comprise an algorithm to determine a risk factor, based on the identified characteristics. For example, an account having “suspicious location,” cryptocurrency transaction system 101 can assign 5 points to the risk factor for the account. For an account having “suspicious location,” and “account expiring soon,” cryptocurrency transaction system 101 can assign 15 points to the risk factor for the account, that is, 5 points for having “suspicious location,” and 10 points for having “account expiring soon.” That said, different characteristics may be assigned different point values. For example, “account expiring in a week” may have greater risk points than “account expiring in a month.” Cryptocurrency transaction system 101 may weight different characteristics and calculate a risk factor for an account. For example, assume that “account expiring in a week” is a riskier characteristic than “account expiring in a month.” Thus, the weight for “account expiring in a week” is 3, and the weight for “account expiring in a month” is 1. For an account having “suspicious location,” and “account expiring in a week,” then cryptocurrency transaction system 101 may assign 35 for the risk factor of the account, that is, 5 points for having “suspicious location,” 30 points for having “account expiring in a week” (10×3). In another example, for an account having “suspicious location,” and “account expiring in a month,” cryptocurrency transaction system 101 may assign 15 for the risk factor of the account, that is, 5 points for having “suspicious location” and 10 points for having “account expiring in a month.”

Cryptocurrency transaction system 101 may be configured to receive a preference for warning. In some embodiments, cryptocurrency transaction system 101 may be configured to receive the request from user device 107, or from another system. Cryptocurrency transaction system 101 may be configured to store the preference to database 105. To avoid too many notifications, a user may choose to be notified when the transaction is in extreme risk only. Cryptocurrency transaction system 101 may be configured to provide different risk levels, such as, extreme risk, high risk, or low risk for a user to selected. A user would only receive notification when the account in question exceeds a certain risk level. For example, a user may prefer to be notified when the account in question is in extreme risk, high risk, or low risk. Thus, the preference may include risk threshold. Cryptocurrency transaction system 101 may be configured to compare risk factor with risk thresholds. When the risk factor is greater than the risk threshold, then cryptocurrency transaction system 101 may be configured to send a command to display on user device 107 via network 103.

Network 103 may be configured to provide communications between components of FIG. 1. For example, network 103 may be any type of network (including infrastructure) that provides communications, exchanges information, and/or facilitates the exchange of information, such as the Internet, a Local Area Network (e.g., Ethernet, WiFi, etc.), a cellular network, or other suitable connection(s) that enables cryptocurrency transaction system 101 to send and receive information between the components of system 100. In some embodiments, network 103 may be a private network or a virtual private network (VPN). Standard encryption algorithms may be used when transferring information from one component to another.

Database 105, in some embodiments, may be implemented as a relational database or a non-relational database configured to store information. Database 105 may include one or more memory devices that store information and are accessed and/or managed through network 103. By way of example, database(s) 105 may include Oracle™ databases, Sybase™ databases, or other relational databases or non-relational databases, such as Hadoop sequence files, HBase, or Cassandra. The databases or other files maybe maintained by cryptocurrency transaction provider 101 and/or by a third party and may include, for example, data and information related to cryptocurrency accounts, geographic location information, publicly available information, etc. Systems and methods of the disclosed embodiments, however, are not limited to separate databases. Database 105 may also include computing components (e.g., database management system, database server, electronic processor, memory, storage, etc.) configured to receive and process requests for data stored in memory devices of database(s) 105 and to provide data from database 105.

In some embodiments, database 105 may include database management system (DBMS) that is configured to control the collection, storage, retrieval, and management of data in database 105. For example, DBMS may be a SQL software on relational databases. In some embodiments, SQL software may provide application programming interface (API) to store and retrieve data in a database.

Third party device 109, in some embodiments, may be implemented as a computing device, such as, a server, a general-purpose computer, a mainframe computer, or the like. In some embodiments, third party device 109 may be implemented as a mobile device (e.g., laptop, tablet, phablet, smartphone, smartwatch, or similar mobile computing device, or the like.) Third party device 109 may be configured to send information relating to a cryptocurrency account using a computing device, such as a server, workstation, desktop, or mobile device (e.g., laptop, tablet, phablet, smartphone, smartwatch, or similar mobile computing device) via network 103. Third party device 109 may be configured to set up a communication with components in FIG. 1 using network 103. In some embodiments, third party 109 may be an entity or source providing information regarding known fraudulent cryptocurrency accounts. In some embodiments, third party device 109 may be operated, used, or owned by a governmental agency, e.g., FBI, IRS; or a non-governmental agency, e.g., a private bank, a cryptocurrency exchange, the Anti-Phishing Working Group, etc. In some embodiments, third party device 109 may be a crowd-sourcing device configured to collect and send information to cryptocurrency transaction system 101. Third party device may be operated, used, or owned by a user, with each user providing information on the trustworthiness of cryptocurrency accounts.

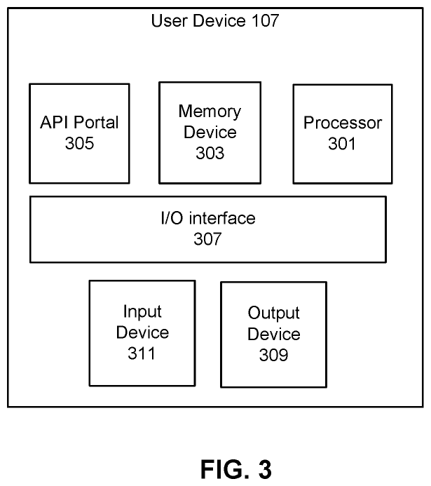

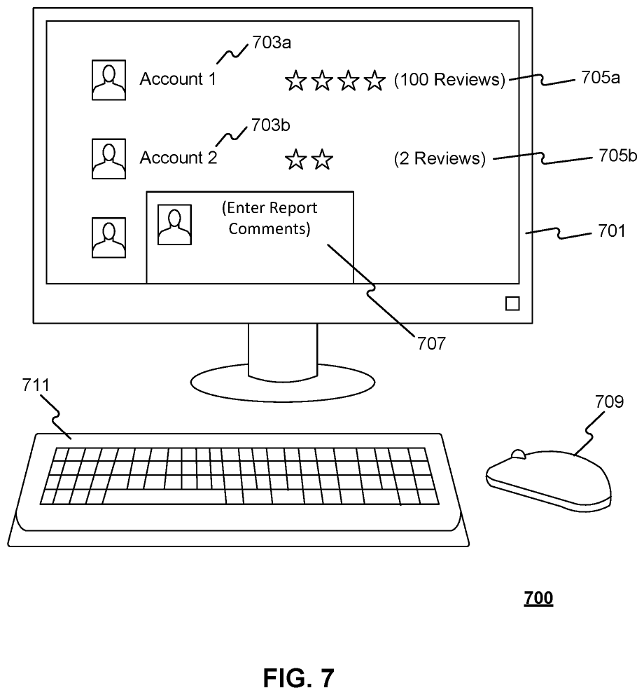

User device 107 in some embodiments, may be implemented as a computing device, such as, a server, a general-purpose computer, a mainframe computer, or the like. In some embodiments, user device 107 may be implemented as a mobile device (e.g., laptop, tablet, phablet, smartphone, smartwatch, or similar mobile computing device, or the like). In some embodiments, user device 107 may be configured to execute software instructions stored on one or more memory devices to perform one or more operations consistent with the disclosed embodiments. In some embodiments, user device 107 may be operated, used, or owned by a user. The user may be a cryptocurrency account holder, an entity, an Exchange (an institution that allows customers to trade cryptocurrencies for other assets, such as, fiat money), and/or a customer of a bank, etc. As described below with respect to FIG. 3, user device 107 may be configured with a display and input/output interfaces. User device 107 may be configured to interact with a user using the display and input/output interfaces. As described below with respect to FIG. 7, user device 107 may be configured to contact cryptocurrency transaction system 101 and send a report indicating a risky or fraudulent account. User device 107 may be configured to send a request to investigate an account, or warning preference via network 103. From the interaction with the user, user device 107 may be configured to store the warning preference in a memory device. User device 107 may be configured to receive a command to display risk factor and/or a command to display warning to users.

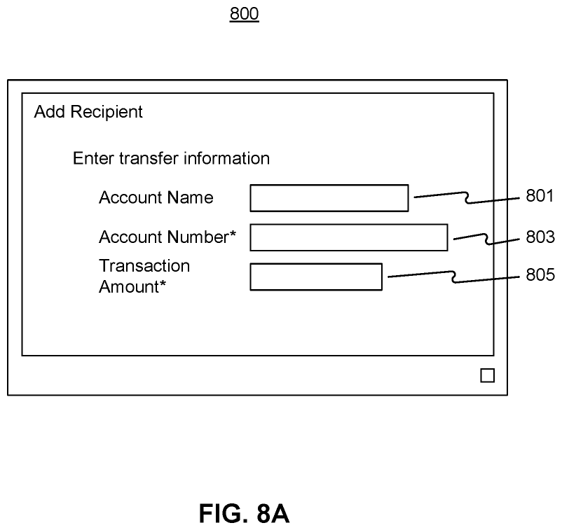

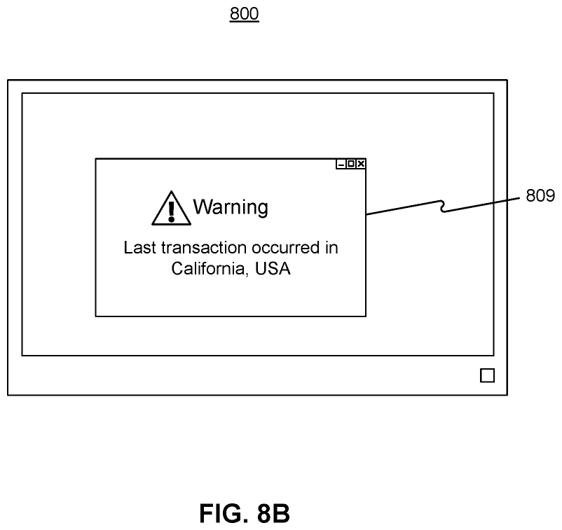

In some embodiments, user device 107 may be configured to support internet browsers. The internet browsers may allow users to install plug-ins, add-ons, or extensions to the browser, where such extensions add functionality to the browser and operate as an integrated part of the browser. For instance, an extension may provide a user access to its additional functionality by modifying a user-interface (UI) of the browser. For example, a browser-based cryptocurrency transaction extension may provide an easy access to cryptocurrency account information and may lower the transaction risk. As described in FIG. 8A, the extension may be configured to collect transaction information, such as, cryptocurrency account and the amount for transaction, when a user enters the information to conduct a transaction on a website. Cryptocurrency transaction system 101 may be configured to receive, from user device 107, the information collected by the user device 107. As described in FIG. 8B, the extension may be configured to provide warning notification of problematic, risky, or fraudulent cryptocurrency accounts to the user on the UI of the browser. The warning notification may be displayed visually on the screen or acoustically through the speaker. In some embodiments, a user may interact with the extension's button or icon (e.g., by clicking it) to select warning preference, and/or to request investigate an account. In some embodiments, the extension may collect cryptocurrency accounts that the user enters, and send a request to investigate the accounts behind the screen.

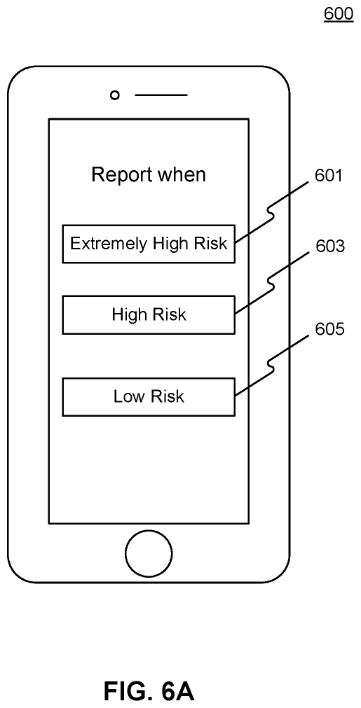

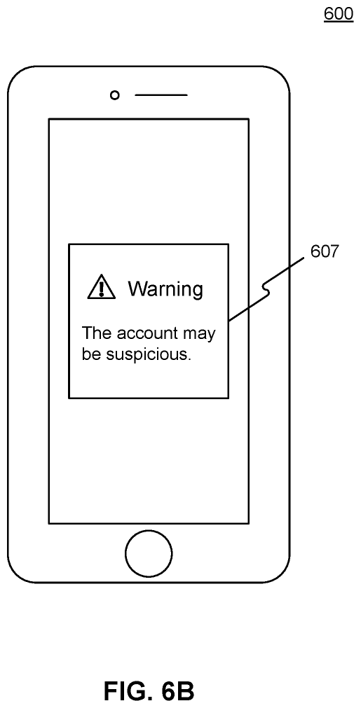

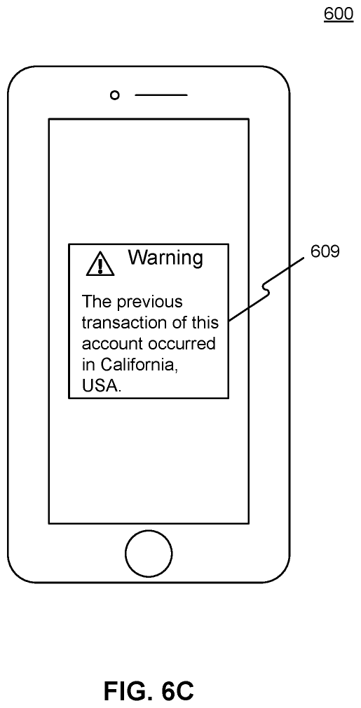

In some embodiments, user device 107 may be configured to run mobile applications. In general, an application is a set of instructions that can be called to cause one or more processors to perform a series of operations for providing a requested service. An application may require input data and produce output data. In some embodiments, the application is a package of JAVA classes describing the series of operations. Input is provided as one or more data structures called parameters and output is provided as a returned data structure. The names and definitions of the input and returned data structures are published as an application programming interface (API). In some embodiments, the application is a script in the operating system language that executes several compiled programs in sequence. As described below with respect to FIG. 6A, a user may interact with the application's button or icon (e.g., by clicking it) to select warning preference, and/or to request investigate an account. As described below with respect to FIGS. 6B and 6C, the application may be configured to provide warning notification of problematic, risky, or fraudulent cryptocurrency accounts to the user on the screen. The warning notification may be displayed visually on the screen or acoustically through the speaker.

As would be recognized by one of skill in the art, the description of system 100 in FIG. 1 is not intended to be limiting. In some embodiments, additional elements may be added, and/or the depicted elements of system 100 may be combined, divided, modified, or removed. For example, envisioned embodiments may implement a superset or a subset of the depicted elements of system 100.

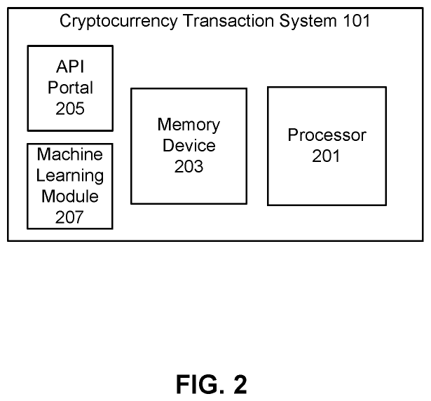

FIG. 2 is a block diagram of cryptocurrency transaction system 101. Cryptocurrency transaction system 101 may comprise at least one processor 201, at least one memory device 203, an Application Programming Interface (API) portal 205, and a machine learning module 207.

Consistent with disclosed embodiments, processor 201 may be implemented as central processing unit (CPU), graphical processing unit (GPU), or similar microprocessor having one or more processing cores. Processor 201 may include one or more known processing devices, such as a microprocessor from the Pentium™ or Xeon™ family manufactured by Intel™, the Turion™ family manufactured by AMD™, or any of various processors manufactured by Sun Microsystems. Cryptocurrency transaction system 101 may include one or more processors and may further operate with one or more other processors that are remote with respect to processor 201. Processor 201 may be configured to execute operations stored in memory device 203 or operations located remotely from cryptocurrency transaction system 101. For example, processor 201 may be configured to retrieve information stored in database 105. Based on the information, processor 201 may be configured to identify characteristics associated with a cryptocurrency account. Based on the characteristics, processor 201 may be configured to determine a risk factor for the account. In some embodiments, processor 201 may be configured to compare the risk factor with a pre-determined value, and when the risk factor is greater than the pre-determined value, processor 201 may be configured to send a command to display to user device 107.

Memory device 203 may include non-transitory memory containing instructions, such as a computer hard disk, random access memory (RAM), removable storage, or remote computer storage. In some aspects, memory device 203 may be configured to store data and instructions, such as software programs. For example, memory device 203 may be configured to store data and instructions. In some aspects, processor 201 may be configured to execute non-transitory instructions and/or programs stored on memory device 203 to configure cryptocurrency transaction system 101 to perform operations of the disclosed systems and methods. In various aspects, as would be recognized by one of skill in the art, processor 201 may be configured to execute non-transitory instructions and/or programs stored on a remote memory to perform operations of the disclosed systems and methods.

API portal 205 may be configured to communicate with database 105, user device 107, and third party device 109, and facilitates managing communication with system 100. API portal may be configured to receive/send data to and from user device 107, third party device 109, and database 105.

In some embodiments, machine learning module 207 may be trained using supervised models. Supervised models are a type of machine learning that provides a machine learning module with training data, which pairs input data with desired output data. The training data may provide a knowledge basis for future judgment. Machine learning module 207 may be configured to receive sets of training data, which comprises data with a “characteristic tag” and data without a “characteristic tag.” For example, the training data comprises transaction data with “suspected of money laundering” tags and common transaction data that has no tag. Machine learning module 207 may learn to identify “suspected of money laundering” by applying a learning algorithm to the set of training data. Machine learning module 207 may be configured to receive sets of test data, which are different from the training data and has no tag. Machine learning module 207 may identify the test data having the “characteristic.” For example, receiving sets of test data, machine module 207 may identify those data that are “suspected of money laundering.” This may allow the machine learning developers to better understand the performance of the training, and thus make some adjustments accordingly.

In additional or alternative embodiments, machine learning module 207 may be trained using unsupervised models. Unsupervised models are a type of a machine learning using untampered data which are not labelled or selected. Applying algorithms, the machine learning module identifies commonalities in the data. Based on the presence and the absence of the commonalities, the machine learning module may categorize future received data. Machine learning module 207 may employ historical transactions data in identifying characteristics associated with accounts, such as those discussed above. For example, machine learning module 207 may identify commonalities from the historical transactions data of many cryptocurrency accounts, which only receive transactions. When an account in question has the commonalities, then machine learning module 207 may determine that the account in question is “suspected of money laundering.” Similarly, machine learning module 207 may identify commonalities from the historical transactions data of many cryptocurrency accounts, which involve in many transactions with a fraudulent account. When an account in question has the same commonalities, then machine learning module 207 may determine that the account in question is “linked to a fraudulent account.” Further, machine learning module 207 may be configured to store these characteristics in database 105. This identified characteristics may help determine whether a future transaction may be problematic, and may help predict a risk level of a future transaction. The algorithms may include linear regression, logistic regression, linear discriminant analysis, classification and regression trees, naïve Bayes, k-nearest neighbors, learning vector quantization, support vector machines, bagging and random forest, and/or boosting and adaboost, or the like.

FIG. 3 is a block diagram of an exemplary user device 107. User device 107, in some embodiments, may be implemented as a computing device, such as a server, a general-purpose computer, a mainframe computer, a mobile device, a laptop, a tablet, a phablet, a smartphone, a smartwatch, or the like. User device 107 may comprise at least one processor 301, at least one memory device 303, an API portal 305, and an input/output (I/O) interface 307, an output device 309, and an input device 311.

Processor 301 may be implemented as a central processing unit (CPU), a graphical processing unit (GPU), or one or more similar microprocessor(s) having one or more processing cores. Processor 301 is interconnected with memory device 303, API portal 305, I/O interface 307, display 309, and speaker 311. Processor 301 may be configured to execute instructions stored in memory device 303. Processor 301 may be configured to transmit signal to output device 309 via I/O interface 307. Processor 301 may be configured to receive information entered by users via I/O interface 307. For example, a user may enter a report of a fraudulent cryptocurrency using input device 311 and I/O interface 307. Processor 301 may be configured to generate a request to investigate a cryptocurrency account and send the request to cryptocurrency transaction system 101 via network 103. In some embodiments, processor 301 may be configured to generate the request using a scheduling function, i.e., a time-based job scheduler.

Memory device 303 may comprise a non-volatile storage unit (e.g. Erasable Electronic Programmable Read Only Memory (“EEPROM”), Flash Memory, and the like) and a volatile storage unit (e.g. random access memory (“RAM”), or the like. Instructions that implement the functional teachings of user device 107 may be maintained in memory device 303 and executed by processor 301. Memory device 303 may be configured to store information entered by a user. For example, memory device 303 may store preferences selected by a user.

API portal 305 may be configured to communicate with cryptocurrency transaction system 101, and facilitates managing communication with system 100 via network 103. API portal may be configured to receive requests from processor 101 and/or I/O interface 307.

I/O interface 307 may be interconnect with input device 311, output device 309, and processor 301. I/O interface 307 may include hardware and/or a combination of hardware and software for receiving information input device 311. I/O interface 307 may be configured to process the information and send the information to processor 301. I/O interface 307 may be configured to transmit signals from processor 301 to output device 309.

Output device 309 may be implemented as a monitor, an LCD screen, a speaker, a printer, etc. Output device 309 may be configured to receive signal from I/O interface, and may be configured to display information, such as numbers, graphics, and sound, etc. For example, as described in FIG. 6C, a warning may be displayed visually via a screen. As described in FIG. 8B, a warning may be displayed via LCD screen 800. Input device 311 may be implemented as a keyboard, a mouse, a trackball, an audio input device, a touch screen, or similar device. Input device 311 may be configured to receive information from the interactions with a user. For example, as described in FIG. 7, a user may type in a report using keyboard 711 and mouse 709. Also, as described in FIG. 6A, a user may select a warning preference by interacting with the touch screen.

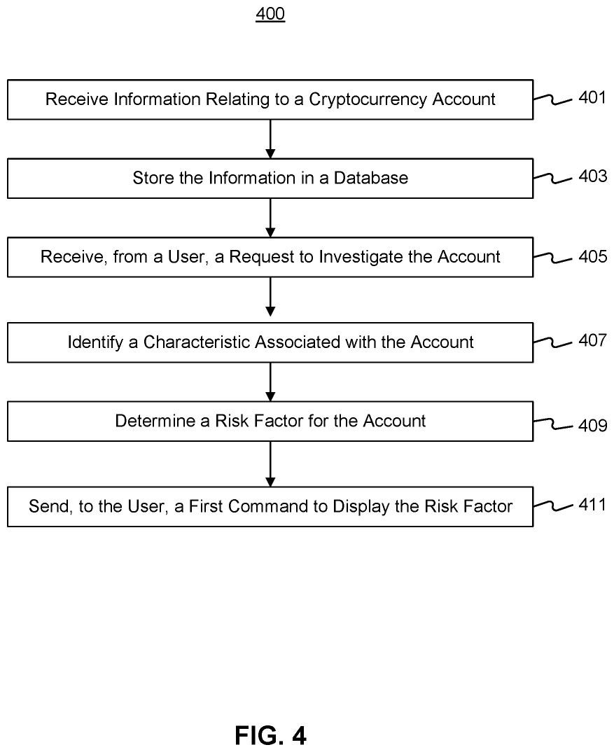

FIG. 4 is a flowchart of an exemplary method for managing cryptocurrency transactions, consistent with disclosed embodiments. In step 401, cryptocurrency transaction system 101 may receive information relating to a cryptocurrency account, from either third party device 109 or user device 107 via network 103. The information may include a complaint from user device 107, a notification that a cryptocurrency account is fraudulent, a list of known fraudulent accounts, or an indication that a cryptocurrency account may be involved in a terrorist group or a problematic organization (e.g., organized crime). The data may also include transaction data on the blockchain relating to the account device “fingerprints,” geographic location information, information associated with a transaction, and/or lifespan of a public key.

Device fingerprints may include a MAC address or other unique serial numbers assigned to the machine hardware, and/or network information. Information associated with a transaction may include a title of the transaction, a location of the transaction, a time when the transaction occurred, an amount of the transaction, a ratio of received transactions to sent transaction, and/or an identification of the accounts involved in the transaction. Geographic location information may include, for example, zip code, physical address, and/or latitude and longitude. In some embodiments, geographic location information may also be determined by the IP address or the entity where the transaction initiated or received, i.e., a cryptocurrency exchange. In some embodiments, the geographic location of a user may be determined by the domain name of a website, which may be collected by a browser extension or a mobile application executing on a user device. Lifespan of the public key contains information of how long the cryptocurrency account may be active; and thus, this may provide an estimate of when the account may be deactivated.

In step 403, cryptocurrency transaction system 101 may store the received information in database 105, consistent with disclosed embodiments. As discussed above, database 105 may be implemented as a relational database or a non-relational database. The received information may thus be stored as rows in tables or in other ways.

In step 405 cryptocurrency transaction system 101 may receive, from user device 107, a request to investigate the account. Such a request may be generated automatically using a scheduling function, i.e., a time-based job scheduler. For example, the scheduler may be set to prompt user device 107 to generate the request at a given time every day. This may be implemented when a user needs to check whether an account is still valid or safe to transact with on a routine basis. In some embodiments, the request may be triggered by a user when entering the account information through user device 107. Upon receiving the request, cryptocurrency transaction system 101 may retrieve information relating to the cryptocurrency account from database 105 and/or a blockchain. The information from a blockchain may be recorded in many blocks, cryptocurrency transaction system 101 may retrieve the information, such as, the amount in past transactions, the cryptocurrency accounts, or addresses that participated in past transactions, etc.

In step 407, cryptocurrency transaction system 101 may identify one or more characteristics associated with the account, based on an analysis that indicates possible risk of future transactions and/or trustworthiness of the account. For example, such characteristics may include “suspicious location,” “account soon to be deactivated,” “problematic organization involved,” “involved in transaction with known fraudulent cryptocurrency accounts,” “transaction amount exceeds 300 units of cryptocurrency,” and/or “ratio of received transactions to sent transactions being too high,” etc. In some embodiments, identifying characteristics may comprise comparing the information with a set of pre-determined parameters. For example, when the geographic location of an account holder falls in a specific area that is known to be the source of problematic accounts, then cryptocurrency transaction system 101 may identify the account as “suspicious location.” As another example, when the remaining lifespan of public key of an account is less than a week, then cryptocurrency transaction system 101 may identify the account as “account soon to be deactivated.” New keys may be generated on a blockchain when a new account is created. The new account may be created for a new user joining the blockchain or a new account set up for transaction by an old user. As another example, when a new public key is identified, then cryptocurrency transaction system 101 may identify the account as “a new account” and/or “a new user.” These characteristics may be used as tags for the accounts when sorting them. For example, when monitoring transactions, to allocate our resources efficiently, cryptocurrency transaction system 101 may be configured to filter out the accounts that have not transacted at least 300 units of cryptocurrency. As another example, cryptocurrency transaction system 101 may be configured to flag the accounts with the same characteristics. For example, cryptocurrency transaction system 101 may be configured to flag all accounts that are identified to have “high ratio of received transactions to sent transactions.” Thus, users may gain a better understanding of whether the account is likely to be fraudulent and/or risky.

In some embodiments, such characteristics may be identified by machine learning module 207, based on the historical transactions data. For example, the historical transactions data of a cryptocurrency account indicates that the account only receives transactions, then machine learning module 207 may determine that the account be “suspected of money laundering.” Similarly, the historical transactions data of a cryptocurrency account involves in many transactions with a fraudulent account, then machine learning module 207 may determine that the account be “linked to a fraudulent account.”

In step 409, cryptocurrency transaction system 101 may determine a risk factor for the cryptocurrency account, based on the identified characteristics. A risk factor (or score) indicates how risky it is to engage in a transaction with the cryptocurrency account. A risk factor may be used, for example, to determine whether the account is suspicious or how suspicious the account is. For example, one range of risk factors would typically indicate a low risk, another range may indicate a suspicious account, and yet another range may indicate a clearly fraudulent account. The following exemplary algorithm illustrates how the characteristics can be used to determine a risk factor for an account:

1. If Suspicious location AND Account expiring AND Ratio of received transactions to sent transactions being too high THEN risk factor=SUSPICIOUS

2. If Suspicious location AND Ratio of received transactions to sent transactions being too high THEN risk factor=HIGH RISK

3. If Ratio of received transactions to sent being too high THEN risk factor=LOW RISK

4. Otherwise risk factor=SAFE

Some characteristics may be more of a concern than others, thus cryptocurrency transaction system 101 may weight the characteristics when determining the risk factor. In some exemplary embodiments, the algorithm configured to determine a risk factor may weigh the identified characteristics. An exemplary table of characteristics risk points follows:

| Characteristic | Original Points |
|---|---|
| Suspicious Location | 5 |
| Account Expiring Soon | 10 |
| Ratio of Received Transactions to Sent | 30 |
| Transactions | |
| Account involved in Terrorist Organizations | 50 |

Based on the identified characteristics and the table above, cryptocurrency transaction system 101 may determine a risk factor for the account in question. For example, assume that “account expiring in a week” is a riskier characteristic than “account expiring in a month.” “Account expiring soon” may have a standard risk point of 10, the weight for “account expiring in a week” may be 3, and the weight for “account expiring for a month” may be 1. An account having “suspicious location,” and “account expiring in a week,” then cryptocurrency transaction system may assign 35 for risk factor of the account, that is, 5 points for having “suspicious location,” 30 points for having “account expiring in a week” (10×3). In another example, for an account having “suspicious location,” and “account expiring in a month,” then cryptocurrency transaction system 101 may assign 15 for the risk factor of the account, that is, 5 points for having “suspicious location,” 10 points for having “account expiring in a month.” For another example, “ratio of received transactions to sent transaction” could be worth 30 points, the weight for “5:1” may be 2, the weight for “10:1” may be 3, the weight for “above 50:1” may be 4. In this example, for an account having “suspicious location” and “ratio of received transactions to sent transaction being 10:1,” cryptocurrency transaction system 101 may assign a risk factor of 95 for the account, that is, 5 points for having “suspicious location,” 90 points for having “ratio of received transactions to sent transaction being 10:1” (30×3). An account having “account involved in terrorist organizations” and “ratio of received transactions to sent transaction being 50:1,” then cryptocurrency transaction system 101 may assign 170 for risk factor of the account, that is, 50 points for having “account involved in terrorist organizations,” and 120 points for having “ratio of received transactions to sent transaction being 50:1” (30×4).

In step 411, cryptocurrency transaction system 101 may send to user device 107 a command to display the risk factor. User device 107 may then receive the command and display the risk factor. In some embodiments, cryptocurrency transaction system 101 may send the risk factor with the identified characteristics to user device 107. User device 107 may then compare the risk factor with the stored risk threshold. When the risk factor is greater than the risk threshold, then user device 107 may display warning notification to the user, via output device 309. The warning notification may include the risk factor and the identified characteristics.

In some embodiments, third party device 109 may be operated by a user, and cryptocurrency transaction system 101 may receive the cryptocurrency account information directly from the user. To verify the information provided by a user, cryptocurrency transaction system 101 may investigate the user. For example, a user may report that a merchant's cryptocurrency account is untrustworthy based on information that the merchant breached an agreement.

After receiving such information relating to an account, cryptocurrency transaction system 101 may retrieve historical transaction information from the blockchain relating to the user's cryptocurrency account. Based on the retrieved information, cryptocurrency transaction system 101 may analyze historical transactions of the user and verify whether the user participated in a transaction with the reported account. Cryptocurrency transaction system 101 may be configured to determine whether the user is trustworthy. Determining whether the user is trustworthy may comprise determining whether the amount in the transaction matches the alleged amount in the report. In some embodiments, cryptocurrency transaction system 101 may be configured to compare the information retrieved from a digital ledger or blockchain against the information in the report. The more matches cryptocurrency transaction system 101 determines, the more likely the user is to be determined as trustworthy. In some aspects, to verify the user, cryptocurrency transaction system 101 may be configured to receive some credentials for verification, for example, use name, passwords, verification code, etc. In some embodiments, if the user is determined to be untrustworthy, cryptocurrency transaction system 101 may filter out the report provided by the user.

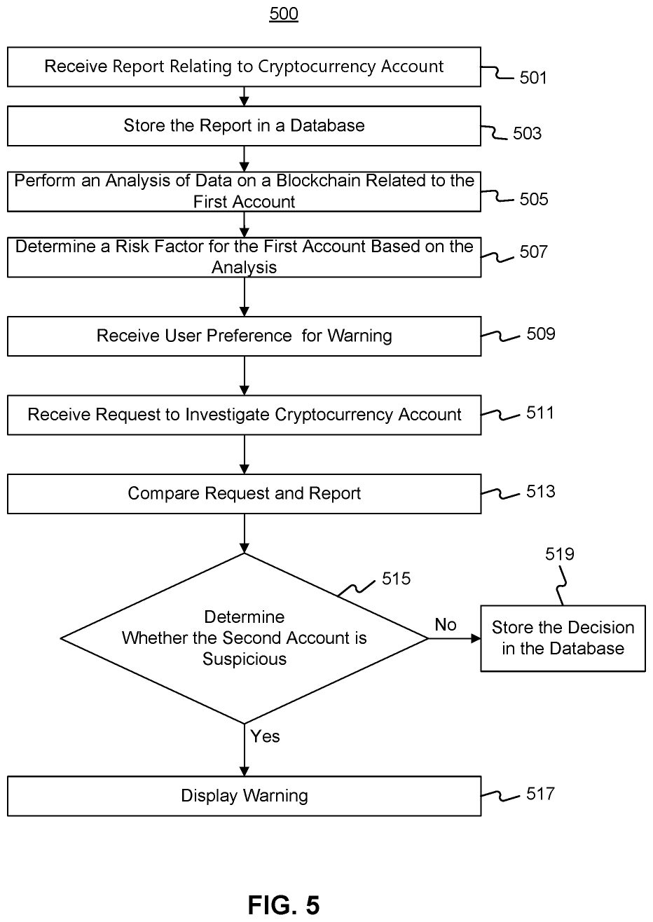

FIG. 5 is another flowchart of an exemplary method for managing cryptocurrency transactions, consistent with disclosed embodiments. In step 501, cryptocurrency transaction system 101 may be configured to receive a report relating to a cryptocurrency account. The report may contain an indication of the trustworthiness of account in question. The report may include a notification that a cryptocurrency account is fraudulent, a list of known fraudulent accounts, or an indication that a cryptocurrency account may be involved in a terrorist group or a problematic organization. The report may be sent from user device 107 and/or third party device 109 via network 103. In some aspects, the information may be obfuscated or encrypted according to methods known to one of skill in the art. For example, the information may be encrypted with a cryptographic key. Upon receiving the information, cryptocurrency transaction system 101 may be configured to decrypt the information.

In step 503, cryptocurrency transaction system 101 may store the report in database 105. Before storing the report, cryptocurrency transaction system 101 may be configured to verify the information in the report provided by a user and determine whether the user is trustworthy, based on historical transaction information retrieved from a blockchain or other ledger. In some aspects, to verify the user, cryptocurrency transaction system 101 may be configured to receive some credentials for verification, for example, user name, password, verification code, etc. As discussed above, database 105 may be implemented as a relational database or a non-relational database. The received report and the information of an account may thus be stored as rows in tables or in other ways.

In step 505, cryptocurrency transaction system 101 may perform an analysis of a blockchain related to a first account. Cryptocurrency transaction system 101 may retrieve transaction data from a digital ledger or blockchain relating to the account device “fingerprints,” geographic location information, information associated with a transaction, and/or lifespan of a public key, etc., based on the indication of an account in the received report.

In some embodiments, analyzing an account may comprise cryptocurrency transaction system 101 identifying one or more characteristics associated with the account, based on the retrieved data from a digital ledger or blockchain. For example, such characteristics may include “suspicious location,” “account soon to be deactivated,” “problematic organization involved,” “involved in transaction with known fraudulent cryptocurrency accounts,” and/or “ratio of received transactions to sent transactions being too high,” etc.

In some embodiments, cryptocurrency transaction system 101 may be configured to identify one or more characteristics associated with the account, based on the report from a user and the verification of the user. For example, if the user is verified to be trustworthy, cryptocurrency transaction system 101 may identify a characteristic based on the complaint in the report. That is, the report indicates that an account is fraudulent, then after verifying the trustworthiness of the user, cryptocurrency transaction system 101 can assign “fraudulent” as a characteristic to the account.

In step 507, cryptocurrency transaction system 101 may determine a risk factor for the first account, that is, an indication of the trustworthiness of the account. As discussed above, a risk factor indicates how risky it is to engage in a transaction with the cryptocurrency account. A risk factor may be used, for example, to determine whether the account is suspicious or how suspicious the account is. For example, one range of risk factors would typically indicate a low risk, another range may indicate a suspicious account, and yet another range may indicate a clearly fraudulent account.

In step 509, cryptocurrency transaction system 101 may receive, from user device 107, a preference for warning. The preference may include the form of notification. For example, the user may choose to be warned by an alarm from a speaker, a text message, and/or a popped up window. Further, the user may specify whether the warning should contain the reason why the account is determined to be problematic. For example, as described below with respect to FIG. 6B, the warning message may include the fact that the account is suspicious. As described below with respect to FIG. 6C, on the other hand, the warning message may include an identified characteristic of the account. The preference may include a risk threshold. For example, a user may prefer to be notified when the account in question is in extreme risk, high risk, or low risk. User prefers to be notified only when the risk factor is greater than the threshold.

As described above, user device 107 may be implemented as a mobile device configured to execute a mobile application. In some embodiments, user device 107 may be implemented as a computing device that support a browser extension on an internet browser. As described in FIG. 6A, a user may interact with the application's button or icon (e.g., by clicking it) to select warning preference. Then, user device 107 may be configured to store the preference in memory device 303 of user device 107 and send the preference to cryptocurrency transaction system 101 via network 103. In some embodiments, a user may select his/her preference using input device 311 of user device 107.

In step 511, cryptocurrency transaction system 101 may receive, from user device 107, a request to investigate a cryptocurrency account, the request including an identification of the second account. For example, the indication may be the public key, the account name, the account's holder information, an IP address, and/or a location. As described above, such request may be generated automatically using a scheduling function, i.e., a time-based job scheduler. For example, the scheduler may be set to generate the request at a given time every day. In some embodiments, the request may be triggered by a user when entering the account information through user device 107. The request may be transmitted from user device 107 to cryptocurrency transaction system 101 via network 103. In some aspects, the request may be obfuscated or encrypted according to methods known to one of skill in the art. For example, the request may be encrypted with a cryptographic key. Upon receiving the information, cryptocurrency transaction system 101 may be configured to decrypt the request.

In step 513, cryptocurrency transaction system 101 may be configured to compare the request with the report. The indication of the second account in the request may be a piece of information, such as a public key, an account name, an account's holder information, an IP address, and/or a location. Cryptocurrency transaction system 101 may compare the piece of information with the information of the first account. For example, if the public key of the second account matches the public key of the first account, then the second account and the first account are identical. On the other hand, if the information does not match, then the second account may be different from the first account, and thus, more information of the second account needed to complete the request of investigation.

In step 515, based on the comparison, cryptocurrency transaction system 101 may be configured to determine whether the second account is suspicious. For example, if the second account is determined to be identical to the first account and the first account has a risk factor greater than the risk threshold, cryptocurrency transaction system 101 may determine the second account to be suspicious. On the other hand, if the information does not match, and the second account is not the first account, then cryptocurrency transaction system 101 may determine the second account to be “not suspicious.”

In step 517, user device 107 may display a warning. User device 107 may receive the command and display the risk factor. In some embodiments, cryptocurrency transaction system 101 may send the risk factor with the identified characteristics to user device 107. User device 107 may then compare the risk factor with the stored risk threshold. When the risk factor is greater than the risk threshold, then user device 107 may display warning notification to the user, via output device 309. The warning notification may include the risk factor and the identified characteristics.

In step 519, cryptocurrency transaction system 101 may be configured to store the decision in database 105. If the second account is determined to be “not suspicious,” cryptocurrency transaction system 101 may determine that more detailed information is needed for the second account and may be configured to store the decision of the second account to database 105. For example, the second account may be categorized in the whitelist of the cryptocurrency account list. If the second account is determined to be “suspicious,” then cryptocurrency transaction system 101 may store the decision in database 105. Cryptocurrency transaction system 101 may be configured to store the information and the decision in a database 105 using software instructions, such as, Structured Query Language (SQL). As discussed above, database 105 may be implemented as a relational database or a non-relational database. The received information and decision may thus be stored as tables in database 105.

FIG. 6A illustrates an exemplary mobile device 600 that may be configured to provide options for the user to select his/her preference. Specifically, mobile device 600 may execute an application that provides three possible risk thresholds: extremely high risk 601, high risk 603, and low risk 605. A user may prefer to be notified when the account in question is in extreme risk, high risk, or low risk. Mobile device 600 may be configured to send the user's selection to cryptocurrency transaction system 101. Cryptocurrency transaction system 101 may be configured to compare risk factor with risk thresholds. When the risk factor is greater than the risk threshold, then cryptocurrency transaction system 101 may be configured to send a command to display on user device 107 via network 103. In some embodiments, mobile device 600 may be configured to store the user's selection in the memory device of mobile device 600. Cryptocurrency transaction system 101 may be configured to send a risk factor to mobile device 600. Mobile device 600 may be configured to compare the risk factor and the stored risk threshold, and prompt a warning notification when the risk factor is greater than the stored risk threshold.

FIG. 6B illustrates a warning presented to a user on a mobile device according to a second user preference, namely a “yes/no” indication. That is, if a risk factor is above a threshold, then pop-up 607 will be displayed. If the risk factor is below the threshold, no pop-up will be provided.

FIG. 6C illustrates a warning display according to yet another user preference. Specifically, mobile device 600 may display a warning to the user including a message presenting information of interest, such as a geographic location where the cryptocurrency account made a previous transaction. This may help user to determine whether to complete the current transaction. In some embodiments, the text message may include a map that shows the geographic location of the account holder.

FIG. 7 illustrates an exemplary user interface on a computing device 700, with mouse 709, keyboard 711, screen 701. Computing device 700 may be configured to execute a browser extension on an internet browser. User may type in a report relating to a cryptocurrency account in message box 707, using keyboard 711 and mouse 709. Computing device 700 may be configured to send the report to cryptocurrency transaction system 101 via network 103. Screen 701 may be configured to display identifications 703a and 703b of other cryptocurrency accounts. Further, risk factors 705a and 705b associated with cryptocurrency accounts 703a and 703b, respectively, may be displayed. The report may include an indication of an account, information of an account, and detail information of a transaction (e.g., transaction date, transaction amount, transaction time, purpose of the transaction, the number of transactions with the account, and/or hyperlink to a website that the involved party owns, etc.).

FIG. 8A depicts a user interface displaying on a screen of a computing device, consistent with disclosed embodiments. When initiating a cryptocurrency transaction, user 107 may enter account name in box 801, account number in box 803, and transaction amount in box 805. Once the account number in box 803 is populated or account name in box 801 is entered, this may trigger computing device to send a request to investigate to cryptocurrency transaction system 101. The request may comprise the account number and/or other account information. In some aspects, the request may be obfuscated or encrypted according to methods known to one of skill in the art. For example, the request may be encrypted with a cryptographic key. Upon receiving the information, cryptocurrency transaction system 101 may be configured to decrypt the request.

FIG. 8B illustrates an exemplary warning to a user displaying on a screen of a computing device, consistent with disclosed embodiments. A computing device may be configured to receive a command to display a warning, and to display the warning message 809 via a screen 800. In some embodiments, cryptocurrency transaction system 101 may send the risk factor with the identified characteristics to the computing device. Computing device may then compare the risk factor with the stored risk threshold. When the risk factor is greater than the risk threshold, then computing device may display warning notification to the user, via a screen 800. The warning notification may include the risk factor and the identified characteristics.

Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims. Furthermore, although aspects of the disclosed embodiments are described as being associated with data stored in memory device, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

What is claimed is:

1. A system for managing cryptocurrency transactions comprising:
at least one memory device containing instructions; and
at least one processor executing the instructions to perform operations comprising:
receiving, from a third party, information relating to a cryptocurrency account;
storing the information in a database;
receiving, from a user, a request to investigate the account;
identifying a characteristic associated with the account;
determining a risk factor for the account, based at least in part on the characteristic; and
sending, to the user, a first command to display the risk factor.

2. The system of claim 1, wherein:
the user is a first user;
the third party is a second user; and
the operations further comprise verifying the information, based on historic transactions of the third party.

3. The system of claim 1, wherein determining a risk factor comprises determining a geographic location of the account holder.

4. The system of claim 1, wherein the operations further comprise:
receiving, from the user, a risk threshold;
comparing the risk factor with the risk threshold; and
sending a second command to display a warning if the risk factor is greater than the risk threshold.

5. The system of claim 1, wherein determining a risk factor comprises:
analyzing historic transactions relating the account; and
determining, for the account, a ratio of received transactions to sent transactions.

6. The system of claim 1, wherein receiving the request comprises receiving a specification of a communication method for sending the first command.

7. The system of claim 1, wherein the third party is a crowd-sourcing device.

8. The system of claim 1, further comprising an Application Programming Interface (API) portal configured to:
receive the request; and
send the first command.

9. The system of claim 1, wherein receiving the request comprises receiving the request from a browser extension on system of the user.

10. The system of claim 1, wherein receiving the request comprises receiving the request from a mobile application on system of the user.

11. A system for managing cryptocurrency transactions comprising:
at least one processor; and
at least one memory containing instructions that, when executed by the at least one processor, cause the system to perform operations comprising:
receiving, from a third party, a report of a first cryptocurrency account;
storing the report in a database;
performing an analysis of a blockchain related to the first account;
determining a risk factor for the first account based on the analysis;
receiving, from a user, a preference for a warning;
receiving, from the user, a request to investigate a second cryptocurrency account;
comparing the second account with the first account;
determining whether the second account is suspicious, based on the comparison; and
sending a command to display a warning to the user, based on the warning preference, when the second account is suspicious.

12. The system of claim 11, wherein the warning preference comprises a request to display a warning when a risk factor is above a risk threshold.

13. The system of claim 12, wherein determining the risk factor comprises a determination of whether the second account is related to the first account.

14. The system of claim 11, wherein the warning preference comprises a specification of a communication method for sending the command.

15. The system of claim 11, wherein the third party is a government agency.

16. The system of claim 11, wherein the third party is a crowd-sourcing device.

17. The system of claim 11, wherein receiving a preference for a warning comprises receiving a preference for a warning from an Application Programming Interface (API) portal of a system of a user.

18. The system of claim 11, wherein determining the risk factor comprises analyzing historical transactions of the second account.

19. The system of claim 11, wherein the operations further comprise analyzing historical transactions of the first account.

20. The system of claim 11, wherein the operations further comprise:
determining a trust value for the third party; and
storing the report, if the trust value is greater than a predetermined value.
